(19) United States
(12) Patent Application Publication
(10) Pub. No.: US 2022/0006324 A1
(43) Pub. Date: Jan. 6, 2022

(54) Fast charging of electric vehicles while in motion or stationary

(71) Applicants: Eric Aylaian, Carmel, CA (US); Frederick H. Schuchardt, Carmel, CA (US)

(72) Inventors: Eric Aylaian, Carmel, CA (US); Frederick H. Schuchardt, Carmel, CA (US)

(21) Appl. No.: 17/477,961

(22) Filed: Sep. 17, 2021

Related U.S. Application Data
(60) Provisional application No. 63/082,599, filed on Sep. 24, 2020.

(51) Int. Cl. H02J 50/23; H02J 50/27; B60L 50/61; H02J 7/34

(52) U.S. Cl. CPC H02J 50/23; H02J 50/27; H02J 2207/50; H02J 7/345; H02J 2310/46; B60L 50/61

(57) ABSTRACT

Disclosed embodiments facilitate exceptionally fast charging of electric vehicles that may be stationary or in motion. Wireless Power Transfer (WPT) is accomplished by use of high frequency power supplies, transmitting antennas, vehicle receivers and high capacity capacitors within the vehicles. The capacitors may be quickly charged and may be then used to directly power a vehicle and/or charge a vehicle's native battery. A vehicle receiver may wirelessly receive a wave of electrical power and cover the power to DC for further use or transition to the capacitors or vehicle battery.

### CROSS-REFERENCE TO RELATED APPLICATIONS

This is a utility application based upon U.S. patent application Ser. No. 63/082,599 filed on Sep. 24, 2020 and claims the priority date of said application. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to the wireless transfer of energy. More particularly, the invention relates to means and methods of charging electric machinery, such as electric vehicles while such machinery is either in motion or stationary.

### (2) Description of the Related Art

The known related art fails to anticipate or disclose the principles of the present invention.

In the related art, various forms of wireless charging are known, but fail to disclose, anticipate or make obvious the methods and mechanisms of the wireless charging systems disclosed herein.

Thus, there is a need in the art for the disclosed embodiments.

### BRIEF SUMMARY OF THE INVENTION

The present invention overcomes shortfalls in the related art by presenting an unobvious and unique combination and configuration of methods and components to wirelessly, quickly and efficiently transfer significant amounts of electricity to an electric vehicle or receiving system. In general, a capacitor or capacitor system may be integrated into an electric vehicle or the vehicle's battery to leverage the capacitor's ability to nearly instantaneously absorb and discharge power into the battery or directly to the vehicle's electric motors.

In the disclosed embodiments, new speeds and efficiencies in wireless power transfer (WPT) may be achieved by use of high frequency energy waves in a possible range of 1 to 100 GHz. Such transmissions may originate from equipment placed in roadways, at or near stop signs or stoplights or in parking lots. Once a power wave is received, the power may be converted to direct current (DC) before transmission to the vehicle capacitors and/or the vehicle electrical system. Once the energy is sent to the vehicle capacitors, the capacitors may recharge the vehicle battery long after the WPT ends. Since vehicle batteries charge at a much slower rate than capacitors, the disclosed embodiments represent a significant improvement in the related art, as capacitors are used as mobile buffers to accept and store power at a relatively high rate of speed and then slowly recharge the vehicle battery.

These and other objects and advantages will be made apparent when considering the following detailed specification when taken in conjunction with the drawings.

### BRIEF DESCRIPTION OF THE DRAWINGS

FIG. 1 depicts a schematic view of a disclosed system

FIG. 2 depicts a transmission and receiving system

FIG. 3 depicts a sectional view of a rectenna or receiver system

FIG. 4 depicts a top view of a rectenna array or receiver system

FIG. 5 A depicts a process to manufacture rectenna and receiver

FIG. 5 B depicts a process to manufacture rectenna and rectifier

FIG. 6 A depicts a possible wheel or wheel well location for rectenna or receiver

FIG. 6 B depicts a possible frunk or front hood location for rectenna or receiver

FIG. 7 depicts a transmission system

FIG. 8 depicts a sectional view and a plan of a gyrotron system

### REFERENCE NUMERALS IN THE DRAWINGS

100 general embodiment

200 rectenna or receiving antenna or vehicle receiver

205 rectenna array

210 rectifier side of receiving antenna

220 wire in receiving antenna

230 ground plate of receiving antenna

240 dielectric of receiving antenna

250 general process of manufacture of a receiver and rectenna

252 sputtering

254 developing

256 coating resist

258 AL etching

260 exposure

262 resist removal

300 transmitting antenna

400 rectifier, converts AC to DC

600 rectenna Array

700 wireless power transmission lens

800 gyrotron

801 cathode with filament

802 resonance cavity

803 collector

804 microwave mirror

805 vacuum window

806 electron beam

807 microwave beam

808 magnet coils

809 magnetic field

810 high voltage power supply

811 filament power supply

812 cooling water connections

813 electrical insulator

814 high-voltage terminals

815 magnet (possibly, superconducting)

900 vehicle

920 outline representation of a vehicle

1000 electric motor

1100 batteries

1200 capacitor bank

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

### BACKGROUND

The disclosed embodiments address a common issue, colloquially referred to as “range anxiety” wherein an electric vehicle (EV) driver will become anxious during travel due to the current dearth of EV charging stations. Often the range of travel advertised by an EV manufacturer does not hold true in real life driving conditions with the typical EV driver enjoying using the superior acceleration and comfortable high speeds of an EV, thus shortening the effect range. Also, the real life range of an EV is further diminished by manufacturer recommendations to keep the onboard battery charged between 80 to 20 percent of capacity, as a full charge or full discharge have deleterious effects on EV battery life expectancy. Moreover, the stated miles left on a battery while driving are often inaccurate, not accounting for hilly terrain or spirited driving. To make matters even worse for an EV driver, once a charging station is reached, the time needed, even while using a Super Charger, is typically at least 40 minutes which is seven or so times longer than filling the tank of gasoline powered vehicle. Thus, the current state of EV range and usability leaves a great deal to be desired.

The disclosed use of high frequency wireless power transmission and receiving, capacitors integrated into an EV battery and/or EV motors or electrical system and other disclosed components and methods greatly increase the usability of an EV. The disclosed embodiments include wireless power transmission wherever an EV can be expected to drive or park. By use of high frequency wireless power transmission, one or more capacitors of the EV may be charged while the vehicle is stationary or in motion. Charging times may be reduced to seconds. Once charged, the capacitor(s) may recharge the EV battery at the battery's native rate of recharge. The capacitor(s) may also discharge directly in the electric EV motors or other EV components such as the AC or heating system. In some cases, the wireless transmission may need to be converted into DC before charging the EV's capacitor(s).

FIG. 1 is a block diagram of a contemplated system 100 wherein an EV comprises one or more electric motors 1000, one or more traditional EV batteries 1100, a bank or array of capacitors 1200 and a receiver 200 for wireless power transmission. External to the EV is a wireless power transmitter 300 or WPT.

With respect to capacitors, new capacitor technology has been developed that has allowed the power density of capacitor to increase by threefold or more, and their size to decrease by threefold of more.

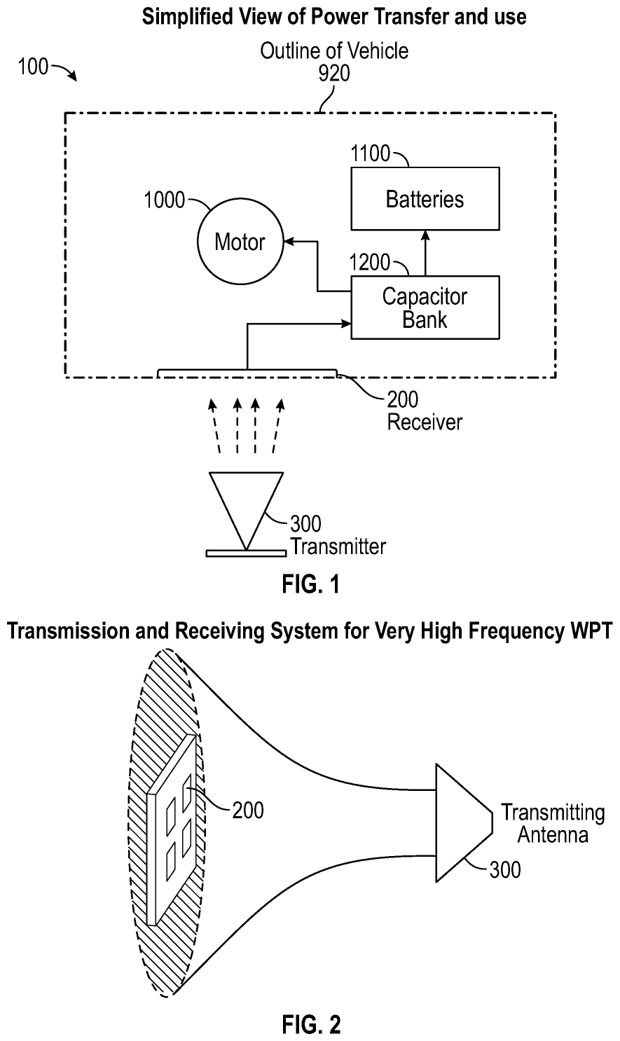

FIG. 2 depicts a wireless power transmission system, which may include are a receiver or rectenna 200 used to receive wireless power transfer, and can have varying capacities, sizes, and other attributes. A receiver 200 may receive a wave of electricity from a transmitter or transmitting antenna 300.

Wireless power transfer (WPT) is a field where tremendous technology improvements have been made. However, transmitting high amounts of power in a short time requires frequencies higher than typical, i.e. in the GHz range. It is anticipated that a disclosed system will utilize a WPT frequency of 40-60 GHz utilizing a high frequency power supply, a transmitting antenna, and a receiver. The receiver in this case is likely to be a rectenna, which is a special type of receiving antenna used for converting high frequency electromagnetic energy into DC electricity. The system of FIG. 2 comports with a contemplated embodiment.

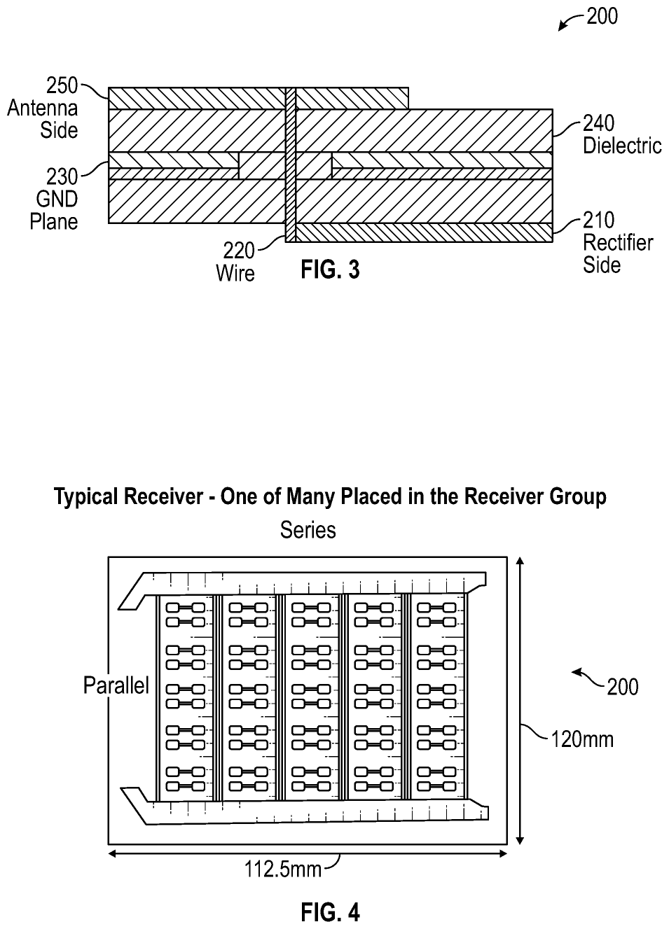

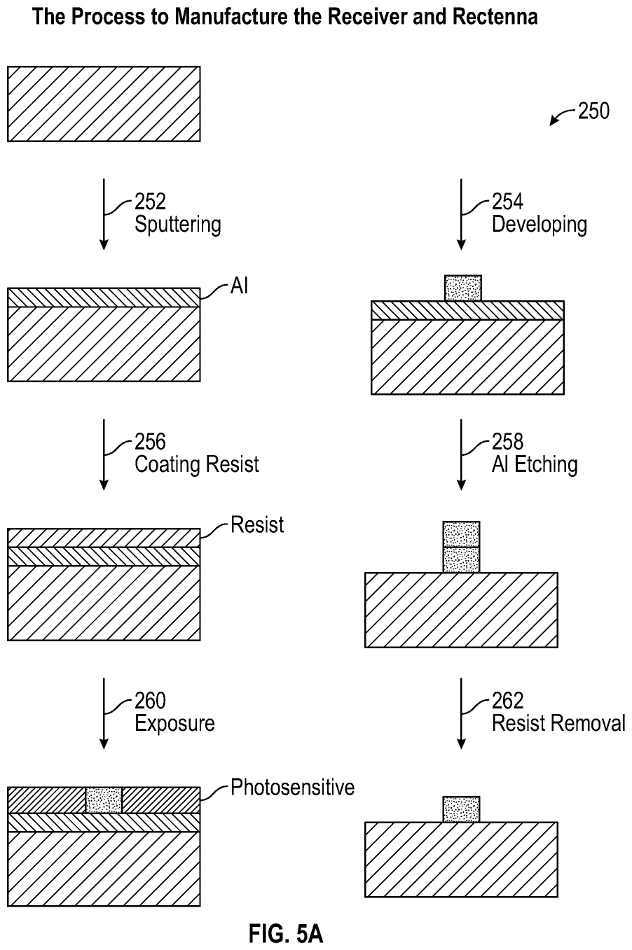

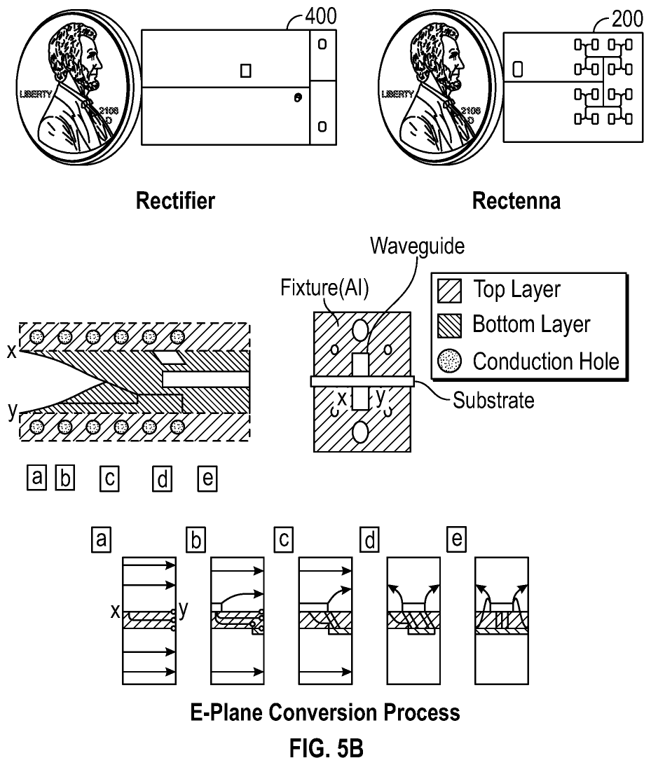

The receiver (rectenna, 200) may be a semiconductor as depicted in FIGS. 3, 4, 5A and 5B. A circuit pattern was fabricated utilizing typical semiconductor processing equipment, in this case designed for 28-60 GHz (FIG. 5A. 5B). The number of rectennas can be changed such that as more are added, more power can be transmitted. In the most likely embodiment, both the size of the rectenna and the number of rectenna will increase such that a minimum of 50 kW can be sent over less than a 5 second period.

FIG. 3 depicts a sectional view of a single wireless power receiver 200. The receiver may have an antenna side that may be disposed in a downward direction to receive electricity or energy from a transmitting antenna. A receiver may have a rectifier side disposed near capacitors, with the capacitors disposed within a vehicle. A receiver may comprise a dielectric 240, ground plane 230, wire 220 and other components.

FIG. 4 depicts a grouping of rectenna receivers.

FIGS. 5A and 5B depicts processes to manufacture a rectenna, a rectifier and other components.

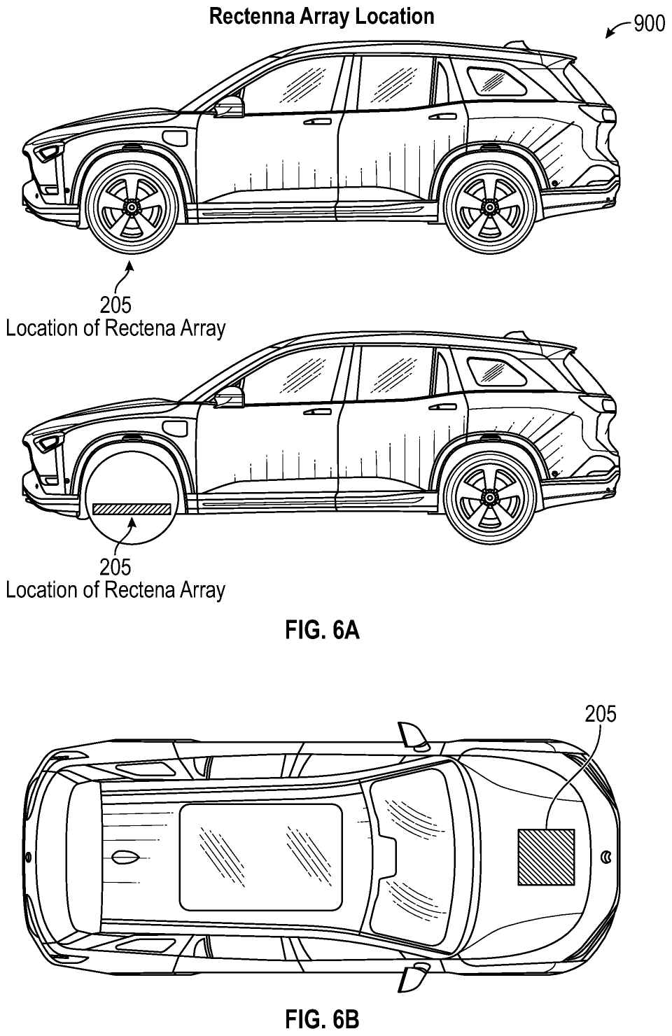

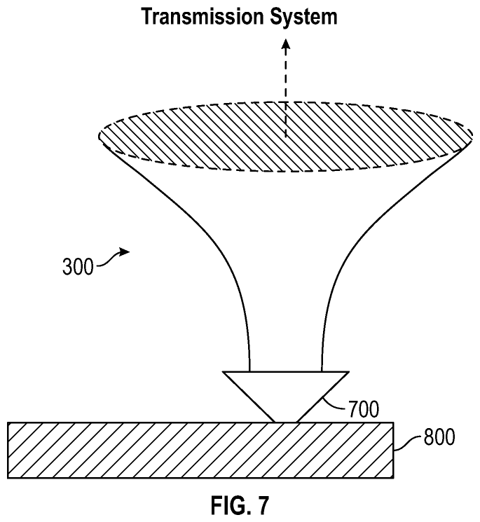

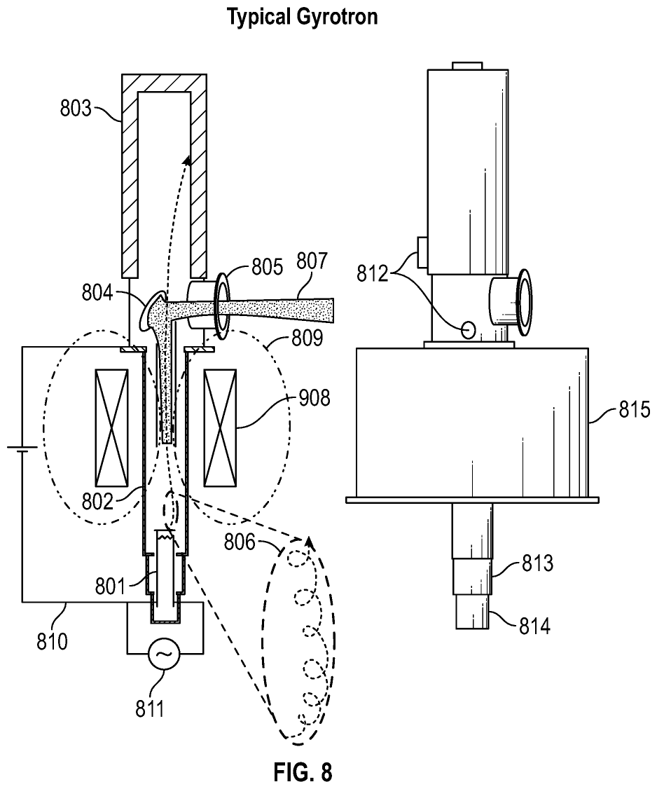

FIGS. 6A and 6B depict contemplated locations 205 for a receiver or rectenna with such locations including under the front 600 of a vehicle 900 or in or below a frunk or trunk. The location of a receiver or rectenna may vary to comport with the features of an EV or a hybrid vehicle.

FIG. 7 depicts a power transmission system. A gyrotron 800 or similar device is used to generate the power needed at the proper frequency, and an in-line antenna is used to focus the beam such that it aligns with the vehicle's rectenna array. Such a system my comprise a gyrotron 800 in communication with a wireless power transmission lens 700.

A gyrotron 800 may be located below grade and used to generate a very high frequency signal with significant energy (for example, 60 MHz with 50 KW of power), and this is then transmitted to a fixed rectenna on a vehicle which receives the wireless power charge, typically down-converted to 1000 VDC into the capacitors. A transmission lens 700 may be located between the gyrotron and the rectenna (typically affixed just above the gyrotron, mounted in the same location as the gyrotron) to properly orient the output beam of the gyrotron into the rectenna array.

A disclosed system may include a power generation source such as a gyrotron with power transmitted to a wireless power transmission lens 700 or other antenna system. Energy may then be transmitted wirelessly to a vehicle receiver 200. The receiver may also be considered a rectenna or receiving antenna. The receiver may convert AC energy to DC energy. Energy from the receiver may be sent to a vehicle capacitor bank 1200 and/or vehicle batteries 1100. Vehicle motors may receive power from either vehicle batteries and/or vehicle capacitors.

What is claimed is:

1. A wireless power transmission (WPT) system for wirelessly charging an electric vehicle, the system comprising:
a) a transmitting antenna wirelessly transmitting power to a receiver;
b) the receiver disposed upon an electric vehicle;
c) the receiver transmitting power to a plurality of capacitors, the capacitors disposed upon the electric vehicle the capacitors transmitting power to vehicle batteries and/or one more electric motors of the electric vehicle.

2. The system of claim 1 wherein the receiver takes the form of a rectenna.

3. The system of claim 2 wherein the rectenna converts AC power from the transmitting antenna to DC power.

4. The system of claim 1 wherein the receiver comprises a rectifier and a rectenna.

5. The system of claim 1 wherein a gyrotron sends power to the transmitting antenna.

6. The system of claim 1 wherein the transmitting antenna comprises a lens.
